(19) United States
(12) Patent Application Publication
(10) Pub. No.: US 2026/0254362 A1
(43) Pub. Date: Aug. 27, 2026

(54) SYNCHRONOUS RECTIFICATION CONTROL APPARATUS AND METHOD, AND FLYBACK SWITCHING POWER SUPPLY

(71) Applicant: WUXI CHIPOWN MICROELECTRONICS CO., LTD., Wuxi (CN)

(72) Inventors: Yang LUO, Wuxi (CN); Yucong MO, Wuxi (CN); Jun YANG, Wuxi (CN); Kuang WANG, Wuxi (CN); Haisong LI, Wuxi (CN); Yangbo YI, Wuxi (CN)

(73) Assignee: WUXI CHIPOWN MICROELECTRONICS CO., LTD., Wuxi (CN)

(21) Appl. No.: 19/208,583

(22) Filed: May 15, 2025

(30) Foreign Application Priority Data
Feb. 25, 2025 (CN) 202510206765.9

(51) Int. Cl. H02M 3/335; H02M 1/36

(52) U.S. Cl. CPC H02M 3/33592; H02M 1/36

(57) ABSTRACT

A synchronous rectification control apparatus and method, and a flyback switching power supply are provided. The apparatus includes: a primary Metal-Oxide-Semiconductor (MOS) transistor, a transformer, a secondary MOS transistor, a primary control chip, and a secondary control circuit. The primary control chip is configured to control the primary MOS transistor to turn on at a valley position to excite a primary inductor of the transformer to increase a primary current, and control the primary MOS transistor to turn off to terminate the excitation of the primary inductor. The secondary control circuit is configured to control the secondary MOS transistor to turn on for a first time during a secondary side demagnetization process of the transformer after the excitation of the primary inductor ends, and to control the secondary MOS transistor to turn on for a second time during a resonance stage after the secondary side demagnetization process ends.

### CROSS-REFERENCE TO RELATED APPLICATIONS

This application claims priority to Chinese Patent Application No. 202510206765.9, filed on Feb. 25, 2025, and entitled “SYNCHRONOUS RECTIFICATION CONTROL APPARATUS AND METHOD, AND FLYBACK SWITCHING POWER SUPPLY”, the entire disclosure of which is incorporated herein.

### TECHNICAL FIELD

The present disclosure generally relates to circuit technology field, and more particularly, to a synchronous rectification control apparatus and method, and a flyback switching power supply.

### BACKGROUND

A flyback switching power supply uses a flyback high-frequency transformer to isolate input and output circuits. When a transistor is turned on, a primary winding of the high-frequency transformer stores energy, and when the transistor is turned off, the energy in the primary winding is released through a secondary winding to power a load. The flyback switching power supply is widely used in various applications as it is simple in control and has a simple peripheral circuit structure. Typical applications include but are not limited to mobile phone chargers, laptop adapters, built-in power supplies for household appliances, industrial power auxiliary power supplies and other fields. The flyback switching power supply can effectively control current and voltage, and improve power conversion efficiency, and is well known for its small size and lightweight design, providing reliable power support for stable operation of various electronic devices.

In applications of fast charging or adapter, the existing flyback switching power supply chooses to use a Discontinuous Conduction Mode (DCM) in some low-power and non-strict efficiency scenarios, that is, an inductor current always reaches 0 during a switching cycle. In other words, when a power switch is turned on, the inductor current is 0. Conventional mainstream solutions in the market are mostly Quasi-Resonant (QR) mode that is a mode between a conventional resonant converter and a hard switch. The QR mode optimizes energy conversion efficiency by controlling on-time of the switch, and reduces switching losses and ElectroMagnetic Interference (EMI). By controlling a primary Metal-Oxide-Semiconductor (MOS) transistor to turn on at a valley position, the QR mode can effectively reduce conduction losses, and has electromagnetic interference performance better than that of a Discontinuous Conduction Mode (DCM) mode.

FIG. 1 illustrates a structural diagram of a conventional synchronous rectification flyback system. C1 is an input capacitor, C2 is an output capacitor, VIN is an input voltage, and VOUT is an output voltage. An operation process of the system can be divided into three stages: (1) primary side excitation; (2) secondary side demagnetization; and (3) LC resonance (or QR quasi-resonance). The specific process is as follows.

A primary control chip 11 controls a primary MOS transistor Q1 to turn on at the valley position. The turn-on process excites a primary inductor of a transformer T and a current rises with the excitation. Afterward, the primary MOS transistor Q1 is turned off, and the excitation ends. A secondary control chip 12 includes a switch control module and a drive module. When the excitation of primary side ends, the secondary side begins to demagnetize and the current decreases with the demagnetization. The switch control module and the drive module process analog signals of a drain DRAIN of the secondary MOS transistor Q2 and the system output terminal voltage VOUT, and turn on the secondary MOS transistor Q2 at a suitable position to reduce losses of the secondary MOS transistor Q2 during the demagnetization. When the demagnetization ends, the secondary MOS transistor Q2 is turned off, and LC resonance occurs after a period of time (both the primary and secondary MOS transistors are turned off) (L refers to transformer inductance, and C refers to equivalent parasitic capacitance Cds of the primary and secondary MOS transistors and the transformer).

FIG. 2 illustrates a curve diagram of a source-drain voltage of the primary MOS transistor near a turn-on moment when the conventional QR mode is adopted for turn-on. At the moment when the primary MOS transistor is turned on, its drain-source voltage difference V ds_pri will drop directly from its valley voltage VDS1 to zero, and energy stored in the parasitic capacitor Cds is dissipated on the primary MOS transistor.

### SUMMARY

Embodiments of the present disclosure provide a synchronous rectification control apparatus and method, and a flyback switching power supply, which may avoid a temperature rise of a primary MOS transistor caused by large turn-on losses of the primary MOS transistor generated when a conventional QR mode is adopted for turn-on.

In an embodiment of the present disclosure, a synchronous rectification control apparatus is provided, including: a primary MOS transistor, a transformer, a secondary MOS transistor, a primary control chip, and a secondary control circuit; where the primary control chip is configured to control the primary MOS transistor to turn on at a valley position to excite a primary inductor of the transformer to increase a primary current, and then control the primary MOS transistor to turn off to terminate the excitation of the primary inductor; and the secondary control circuit is configured to control the secondary MOS transistor to turn on for a first time during a secondary side demagnetization process of the transformer after the excitation of the primary inductor ends, and to control the secondary MOS transistor to turn on for a second time during a resonance stage after the secondary side demagnetization process of the transformer ends, to reduce a drain voltage of the primary MOS transistor before being turned on again.

Optionally, the secondary control circuit includes: a switch control module, configured to output a first control signal during the secondary side demagnetization process of the transformer to control the secondary MOS transistor to turn on at a first moment for a first duration; a turn-on enabling module, configured to output a second control signal in the resonance stage after the secondary side demagnetization process of the transformer ends, to control the secondary MOS transistor to turn on at a second moment for a second duration, where the second moment is later than the first moment; an anti-accidental turn-on module, configured to detect whether a waveform of a drain-source voltage difference of the secondary MOS transistor is distorted, and output a distortion detection result signal to the turn-on enabling module to control timing when the turn-on enabling module outputs the second control signal; and a drive module, configured to drive the secondary MOS transistor to turn on or off based on the first control signal and the second control signal.

Optionally, the switch control module, the drive module, the turn-on enabling module, and the anti-accidental turn-on module are encapsulated in a same chip.

Optionally, the switch control module and the drive module are encapsulated together as a secondary control chip, and the anti-accidental turn-on module and the turn-on enabling module are encapsulated together as a turn-on control chip.

Optionally, the secondary MOS transistor and the secondary control circuit are encapsulated in a same chip.

Optionally, the apparatus further includes: a protocol module, configured to regulate an output terminal voltage VOUT to make the output terminal voltage VOUT meet a set standard.

Optionally, the apparatus further includes: a protocol module, configured to regulate an output terminal voltage VOUT to make the output terminal voltage VOUT meet a set standard; where the protocol module is encapsulated in the turn-on control chip.

Optionally, the apparatus further includes: a protocol module, configured to regulate an output terminal voltage VOUT to make the output terminal voltage VOUT meet a set standard; where the protocol module and the secondary control circuit are encapsulated in a same chip.

Optionally, the secondary control circuit includes: an auxiliary MOS transistor, connected in parallel with the secondary MOS transistor; a synchronous rectification control chip, configured to control the secondary MOS transistor to turn on at a first moment for a first duration during the secondary side demagnetization process of the transformer; and a turn-on control chip, configured to control the auxiliary MOS transistor to turn on at a second moment for a second duration after the secondary MOS transistor is turned off during the resonance stage after the secondary side demagnetization process of the transformer ends.

Optionally, the secondary MOS transistor is encapsulated in the synchronous rectification control chip.

Optionally, the auxiliary MOS transistor is encapsulated in the turn-on control chip.

Optionally, the auxiliary MOS transistor and the secondary MOS transistor are encapsulated in a same chip.

Optionally, the synchronous rectification control chip includes: a switch control module, configured to output a first control signal during the secondary side demagnetization process of the transformer to control the secondary MOS transistor to turn on at the first moment for the first duration; and a drive module, configured to drive the secondary MOS transistor to turn on or off based on the first control signal.

Optionally, the turn-on control chip includes: a turn-on enabling module, configured to output a second control signal in the resonance stage after the secondary side demagnetization process of the transformer ends, to control the auxiliary MOS transistor to turn on at the second moment for the second duration after the secondary MOS transistor is turned off; an anti-accidental turn-on module, configured to detect whether a waveform of a drain-source voltage difference of the secondary MOS transistor is distorted, and output a distortion detection result signal to the turn-on enabling module to control timing when the turn-on enabling module outputs the second control signal; and a second drive module, configured to drive the auxiliary MOS transistor to turn on or off based on the second control signal.

Optionally, the apparatus further includes: a protocol module, configured to regulate an output terminal voltage VOUT to make the output terminal voltage VOUT meet a set standard; where the protocol module is independent of the synchronous rectification control chip and the turn-on control chip, or the protocol module is encapsulated in the synchronous rectification control chip, or the protocol module is encapsulated in the turn-on control chip.

Optionally, the anti-accidental turn-on module is configured to control the turn-on enabling module to output the second control signal through a state machine.

In an embodiment of the present disclosure, a flyback switching power supply including the above synchronous rectification control apparatus is provided.

In an embodiment of the present disclosure, a synchronous rectification control method is provided, including: controlling a primary MOS transistor to turn on at a valley position to excite a primary inductor of a transformer to increase a primary current, and then controlling the primary MOS transistor to turn off to terminate the excitation of the primary inductor; controlling a secondary MOS transistor to turn on for a first time during a secondary side demagnetization process of the transformer after the excitation of the primary inductor ends; and controlling the secondary MOS transistor to turn on for a second time during a resonance stage after the secondary side demagnetization process of the transformer ends, to reduce a drain voltage of the primary MOS transistor before being turned on again.

With the synchronous rectification control apparatus and method, and the flyback switching power supply provided in the embodiments of the present disclosure, the primary MOS transistor is controlled to turn on at the valley bottom position by the primary control chip, so as to excite the primary inductor of the transformer to increase the primary current, and then the primary MOS transistor is controlled to turn off to terminate the excitation of the primary inductor. After the excitation of the primary inductor ends, the secondary MOS transistor is controlled to turn on once more by the secondary control circuit in the resonance stage after the secondary side demagnetization process of the transformer ends, thereby effectively reducing the drain voltage of the primary MOS transistor before being turned on again, reducing turn-on losses of the primary MOS transistor, reducing a temperature rise of the primary MOS transistor, and improving system efficiency.

Further, an anti-accidental turn-on module is provided in the secondary control circuit. Even when the waveform of the drain-source voltage difference of the secondary MOS transistor is distorted, the anti-accidental turn-on module can effectively ensure that the secondary MOS transistor is turned on for the second time at an appropriate time, thereby minimizing turn-on losses of the primary MOS transistor.

Further, each module in the secondary control circuit and the secondary MOS transistor may be integrated in a variety of ways to better meet different application requirements.

### BRIEF DESCRIPTION OF THE DRAWINGS

FIG. 1 is a structural diagram of a conventional synchronous rectification flyback system;

FIG. 2 is a schematic diagram of a curve of a source-drain voltage of a primary MOS transistor near a turn-on moment when a conventional QR mode is adopted for turn-on;

FIG. 3 is a structural diagram of a synchronous rectification control apparatus according to an embodiment;

FIG. 4 is a schematic diagram of related signals of a primary MOS transistor and a secondary MOS transistor at different stages in a synchronous rectification control apparatus according to an embodiment;

FIG. 5 is a schematic diagram showing comparison of curves of a source-drain voltage of a primary MOS transistor near a turn-on moment in a case that a second turn-on mechanism is introduced in an embodiment and in a case that the conventional QR mode is adopted for turn-on as shown in FIG. 2;

FIG. 6 is a structural diagram of a synchronous rectification control apparatus according to an embodiment;

FIG. 7 is a structural diagram of a synchronous rectification control apparatus according to an embodiment;

FIG. 8 is a structural diagram of a synchronous rectification control apparatus according to an embodiment;

FIG. 9 is a structural diagram of a synchronous rectification control apparatus according to an embodiment;

FIG. 10 is a diagram showing distortion detection principle of a waveform of a drain-source voltage difference of a secondary MOS transistor according to an embodiment;

FIG. 11 is a schematic diagram of state changes of a state machine in a case where the state machine is used to implement a function of a turn-on enabling module according to an embodiment;

FIG. 12 is an operation waveform diagram of forward locking of adaptive step second turn-on of a secondary MOS transistor by using a state machine according to an embodiment;

FIG. 13 is an operation waveform diagram of backward locking of adaptive step second turn-on of a secondary MOS transistor by using a state machine according to an embodiment; and

FIG. 14 is a flow chart of a synchronous rectification control method according to an embodiment.

### DETAILED DESCRIPTION

In order to clarify the objects, characteristics and advantages of the disclosure, embodiments of present disclosure will be described in detail in conjunction with accompanying drawings.

For the existing flyback switching power supply in the QR mode, at a moment when its primary MOS transistor is turned on, energy stored in a parasitic capacitor of the primary MOS transistor is dissipated in the primary MOS transistor, causing a temperature rise of the primary MOS transistor. Embodiments of the present disclosure provide a synchronous rectification control apparatus and method, and a flyback switching power supply, where a second turn-on mechanism is introduced for a secondary MOS transistor to further reduce turn-on losses during a turn-on process of a primary MOS transistor, thereby improving system efficiency and reducing a temperature rise of the primary MOS transistor.

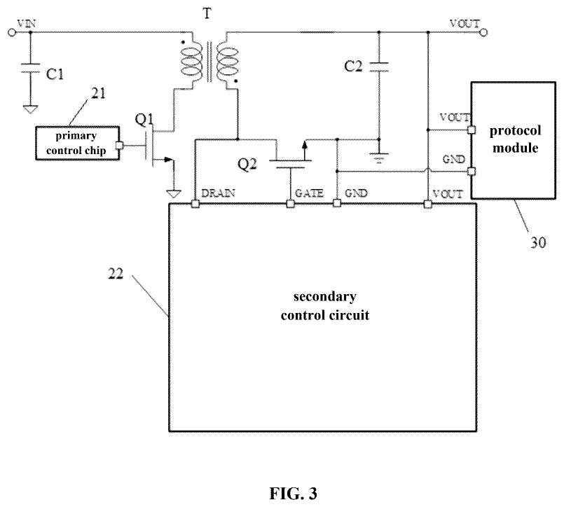

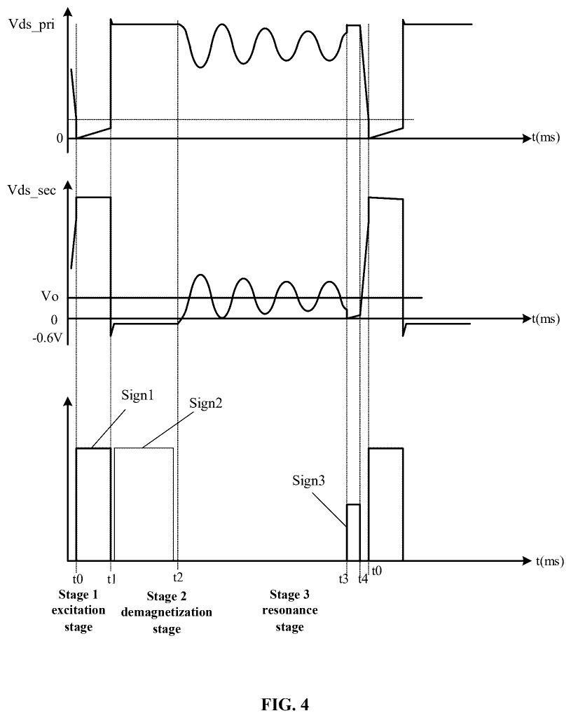

Referring to FIG. 3, FIG. 3 is a structural diagram of a synchronous rectification control apparatus according to an embodiment.

The synchronous rectification control apparatus includes: a primary MOS transistor Q1, a transformer T, a secondary MOS transistor Q2, a primary control chip 21, and a secondary control circuit 22. Capacitors C1 and C2 are input capacitor and output capacitor respectively, VIN is an input terminal voltage, and VOUT is an output terminal voltage. The secondary control circuit 22 includes: a drain DRAIN, a gate GATE, a ground terminal GND, and an output terminal VOUT (for ease of description, the output terminal voltage is also recorded as VOUT hereinafter), which are respectively connected to a drain, a gate, a ground terminal and a source of the secondary MOS transistor Q2, and the source of the secondary MOS transistor Q2 is grounded.

In the embodiment, the primary control chip 21 is configured to control the primary MOS transistor Q1 to turn on at a valley position (i.e., a position where a drain voltage of the primary MOS transistor Q1 is zero) to excite a primary inductor of the transformer T, to increase a primary current, and then control the primary MOS transistor Q1 to turn off to terminate the excitation of the primary inductor. The secondary control circuit 22 is configured to control the secondary MOS transistor Q2 to turn on for a first time during a secondary side demagnetization process of the transformer T after the excitation of the primary inductor ends, and control the secondary MOS transistor Q2 to turn on for a second time during a resonance stage after the secondary side demagnetization process of the transformer T ends, so as to generate a backflow current, which reduces the drain voltage of the primary MOS transistor Q1 before being turned on again, turn-on losses of the primary MOS transistor, and the temperature rise of the primary MOS transistor. Specifically, after the secondary side demagnetization process begins, the secondary control circuit 22 controls the secondary MOS transistor Q2 to turn on for the first time by detecting the drain voltage of the secondary MOS transistor Q2, and turns off the secondary MOS transistor Q2 before the secondary side demagnetization process ends. In the resonance stage after the secondary side demagnetization process of the transformer ends, the secondary control circuit 22 controls the secondary MOS transistor Q2 to turn on once more by detecting the drain voltage of the secondary MOS transistor Q2, and turns off the secondary MOS transistor Q2 after a certain period of time from the turn-on moment.

In some embodiments, the synchronous rectification control apparatus further includes a protocol module 30 configured to regulate the output terminal voltage VOUT to make the output terminal voltage VOUT meet a set standard.

FIG. 4 is a schematic diagram of related signals of a primary MOS transistor and a secondary MOS transistor at different stages in a synchronous rectification control apparatus according to an embodiment.

Vds_pri is a drain-source voltage difference of the primary MOS transistor, and Vds_sec is a drain-source voltage difference of the secondary MOS transistor.

In stage 1 from t0 to t1, i.e., an excitation stage, a control signal Sign1 controls the primary MOS transistor to turn on at a position where the drain-source voltage difference is close to 0, so as to excite a primary inductor of a transformer. At t1, the control signal Sign1 controls the primary MOS transistor to turn off, and the excitation stage ends. During this process, the secondary MOS transistor is in an off state.

In stage 2 from t1 to t2, i.e., a demagnetization stage, after the primary inductor excitation of the transformer ends, a control signal Sign2 controls the secondary MOS transistor to turn on for the first time, and before the demagnetization ends at t2, the secondary MOS transistor is turned off.

In stage 3, i.e., a resonance stage after the demagnetization, a control signal Sign3 controls the secondary MOS transistor to turn on for the second time to generate a backflow current, thereby reducing a drain voltage of the primary MOS transistor Q1 before being turned on again.

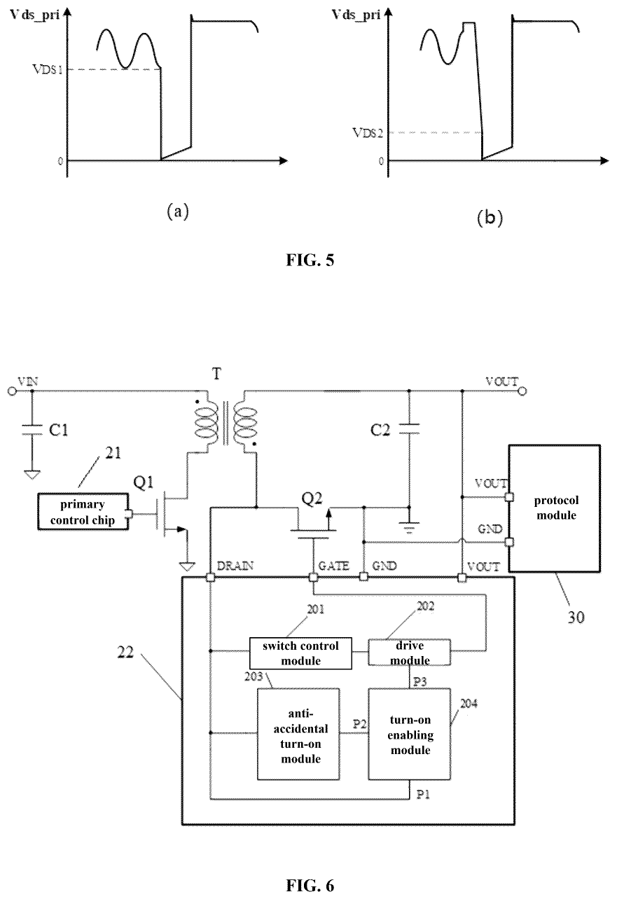

Compared with the existing control mechanism using the QR mode, the synchronous rectification control apparatus provided in the embodiments of the present disclosure introduces a second turn-on mechanism to the secondary MOS transistor, so that before the primary MOS transistor is turned on, the drain voltage of the primary MOS transistor Q1 is reduced, thereby reducing its turn-on losses and improving system efficiency. The principle is explicitly described below in conjunction with FIG. 5.

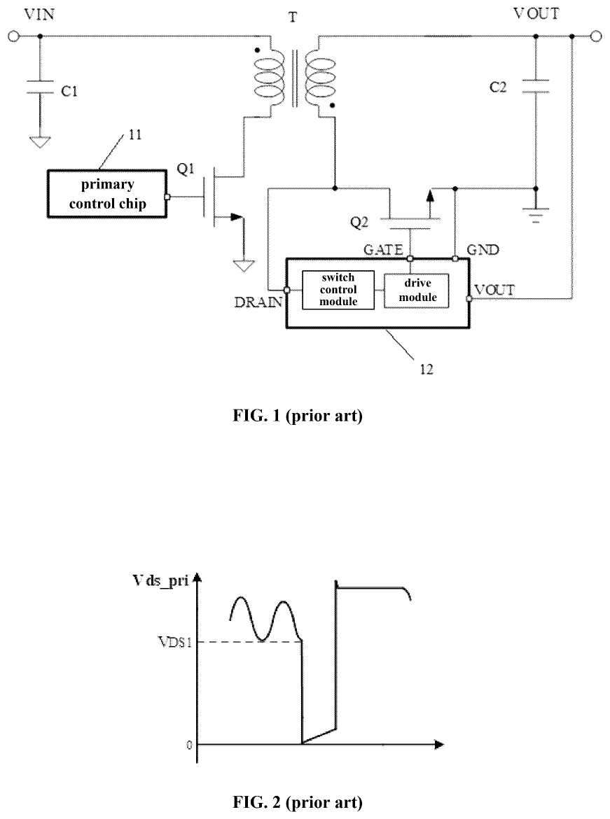

FIG. 5 is a schematic diagram showing comparison of curves of a source-drain voltage of a primary MOS transistor near a turn-on moment in a case that the second turn-on mechanism is introduced in an embodiment and in a case that the conventional QR mode is adopted for turn-on as shown in FIG. 2.

FIG. 5(a) is a schematic diagram of the curve of the source-drain voltage of the primary MOS transistor near the turn-on moment in the case that the conventional QR mode is adopted for turn-on as shown in FIG. 2, and FIG. 5(b) is a schematic diagram of the curve of the source-drain voltage of the primary MOS transistor near the turn-on moment in the case that the secondary MOS transistor is turned on for the second time.

Losses of the primary MOS transistor at the turn-on moment may be represented by a following formula:

$$E = \frac{1}{2} \times {C}_{d s} \times {V}_{d s}^{2} ,$$

where C_{ds} is parasitic capacitance of the primary MOS transistor, and Vas represents a voltage difference between the drain and source of the primary MOS transistor.

Referring to FIG. 5(a) and FIG. (b), when the primary MOS transistor is turned on, the second turn-on mechanism is adopted to reduce the voltage difference between the drain and source (i.e., the drain-source voltage difference) of the primary MOS transistor from existing VDS1 (VDS1 is approximately VIN-N×VOUT, N is a primary-to-secondary transformer turns ratio) to VDS2 (VDS2 is close to 0), thereby reducing the turn-on losses of the primary MOS transistor and effectively improving the system efficiency.

In some embodiments, the secondary control circuit 22 in the synchronous rectification control apparatus shown in FIG. 3 may have a variety of structures, which are described below with examples.

Referring to FIG. 6, FIG. 6 is a structural diagram of a synchronous rectification control apparatus according to an embodiment.

A primary control chip 21 is configured to control a primary MOS transistor Q1 to turn on at a valley position to excite a primary inductor of a transformer T to increase a primary current, and then control the primary MOS transistor Q1 to turn off to terminate the excitation of the primary inductor.

A secondary control circuit 22 includes: a switch control module 201, a turn-on enabling module 204, an anti-accidental turn-on module 203, and a drive module 202.

The switch control module 201 is configured to output a first control signal during a secondary side demagnetization process of the transformer T to control a secondary MOS transistor Q2 to turn on at a first moment for a first duration.

The turn-on enabling module 204 is configured to output a second control signal in a resonance stage after the secondary side demagnetization process of the transformer T ends, to control the secondary MOS transistor Q2 to turn on at a second moment for a second duration, where the second moment is later than the first moment.

The anti-accidental turn-on module 203 is configured to detect whether a waveform of a drain-source voltage difference of the secondary MOS transistor Q2 is distorted, and output a distortion detection result signal to the turn-on enabling module 204 to control timing when the turn-on enabling module 204 outputs the second control signal. The anti-accidental turn-on module 203 may better ensure timing of the second turn-on of the secondary MOS transistor Q2 to avoid accidental turn-on at inappropriate timing.

The drive module 202 is configured to drive the secondary MOS transistor Q2 to turn on or off based on the first control signal and the second control signal.

The first turn-on time (i.e., the first moment) of the secondary MOS transistor Q2 is determined by the switch control module 201 based on a detection result of a drain voltage of the secondary MOS transistor Q2, which is similar to the prior art and is not limited in the embodiments of the present disclosure.

The second turn-on time (i.e., the second moment) of the secondary MOS transistor Q2 is determined based on a detection result of the anti-accidental turn-on module 203 detecting the waveform of the drain-source voltage difference of the secondary MOS transistor Q2, which is described in detail hereafter.

In some embodiments, after the primary side excitation of the transformer T ends, the secondary side begins to demagnetize and a secondary current decreases with the demagnetization. The switch control module 201 processes analog signals at a drain DRAIN and an output terminal of the secondary MOS transistor Q2, and turns on the secondary MOS transistor Q2 for a certain period of time at appropriate timing (i.e., the first moment), thereby reducing losses on the secondary MOS transistor Q2 during the demagnetization process. Afterward, in the resonance stage after the secondary side demagnetization process ends, the anti-accidental turn-on module 203 and the turn-on enabling module 204 process the analog signals at the drain DRAIN and the output terminal of the secondary MOS transistor Q2, and turns on the secondary MOS transistor Q2 for a certain period of time at another appropriate timing (i.e., the second moment), thereby generating a backflow current on a secondary inductor of the transformer T. After the secondary MOS transistor Q2 is turned off, backflow occurs on the primary inductor of the transformer T, forcing drain charges of the primary MOS transistor Q1 to transfer to an input terminal power supply. Before the primary MOS transistor Q1 is turned on, its drain voltage drops to a lower position.

In some embodiments, the switch control module 201, the turn-on enabling module 204, the drive module 202, and the anti-accidental turn-on module 203 may be encapsulated in a same chip which is called an adaptive step turn-on secondary control chip for ease of description. As shown in FIG. 6, the chip includes following terminals: a drain DRAIN, a gate GATE, a ground terminal GND, and an output terminal VOUT, which are respectively connected to the drain, the gate, the ground, and the source of the secondary MOS transistor Q2.

In some embodiments, the secondary MOS transistor Q2 may be also encapsulated into the adaptive step turn-on secondary control chip.

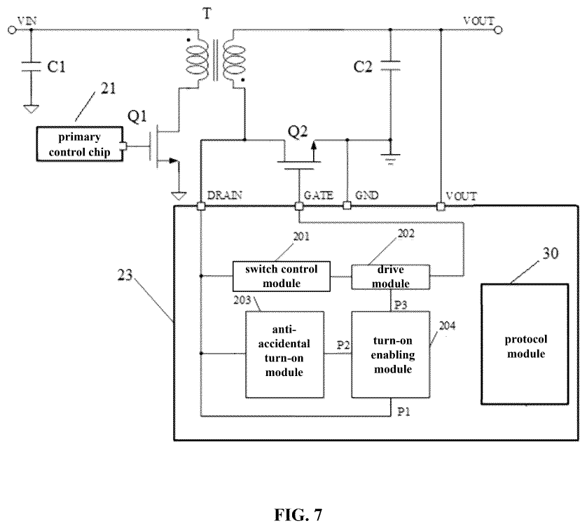

As shown in FIG. 7, the switch control module 201 includes an input terminal and an output terminal. The anti-accidental turn-on module 203 includes an input terminal and an output terminal. The turn-on enabling module 204 includes a leakage voltage sampling terminal P1, a detection control terminal P2 and an output terminal P3. The drive module 202 includes two input terminals and one output terminal, the two input terminals being a drive control terminal and a function control terminal. The drive control terminal is connected to the output terminal of the switch control module 201, and the function control terminal is connected to the output terminal P3 of the turn-on enabling module 204.

In addition, the input terminal of the switch control module 201, the input terminal of the anti-accidental turn-on module 203, and the leakage voltage sampling terminal P1 of the turn-on enabling module 204 are all connected to the drain DRAIN of the chip. The output terminal of the anti-accidental turn-on module 203 is connected to the detection control terminal P2 of the turn-on enabling module 204.

It should be noted that each of the above modules is powered by a stable power supply obtained by preprocessing the output terminal VOUT, and is connected to a common ground with the output terminal VOUT.

As shown in FIG. 7, in some embodiments, the protocol module 30 may be also encapsulated into the adaptive step turn-on secondary control chip 23, which may further improve integration of the chip.

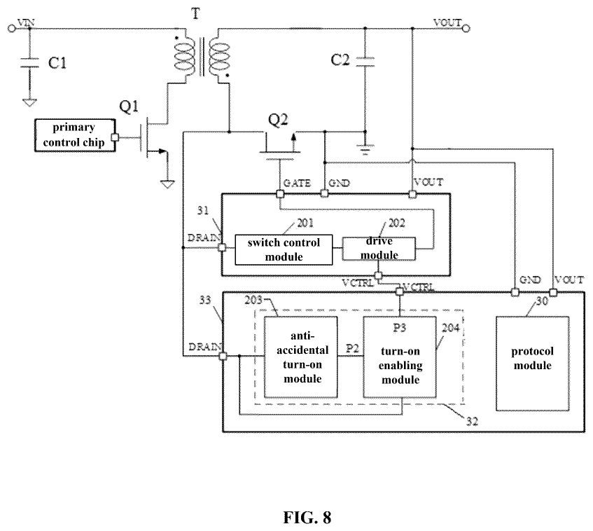

Referring to FIG. 8, FIG. 8 is a structural diagram of a synchronous rectification control apparatus according to another embodiment.

Different from the embodiment shown in FIG. 6, in this embodiment, the switch control module 201 and the drive module 202 are encapsulated in a same chip which is called a secondary control chip 31 for ease of description. The anti-accidental turn-on module 203 and the turn-on enabling module 204 are encapsulated in the same chip which is called a turn-on control chip 32 for ease of description.

The secondary control chip 31 includes following terminals: a drain DRAIN, a gate GATE, a ground terminal GND, and an output terminal VOUT, which are respectively connected to the drain, the gate, the ground, and the source of the secondary MOS transistor Q2. The turn-on control chip 32 includes following terminals: a drain DRAIN, a ground terminal GND, and an output terminal VOUT, which are respectively connected to the drain, the ground, and the source of the secondary MOS transistor Q2. In addition, the secondary control chip 31 further includes an input control terminal VCTRL connected to the function control terminal of the drive module 202. The turn-on control chip 32 further includes an output control terminal VCTRL connected to the output terminal of the turn-on enabling module 204.

In this structure, the secondary control chip 31 is substantially the same as a secondary control chip used in the conventional synchronous rectification flyback system, so that the structure can be realized by only leading out a function control terminal (i.e., the control terminal VCTRL) on a drive module of the conventional system.

In some embodiments, the protocol module 30, the anti-accidental turn-on module 203 and the turn-on enabling module 204 may be encapsulated in a same chip which is called an adaptive step turn-on function protocol chip 33 for ease of description. Terminals of the adaptive step turn-on function protocol chip 33 are the same as those of the above-mentioned turn-on control chip 32, and are not described in detail here.

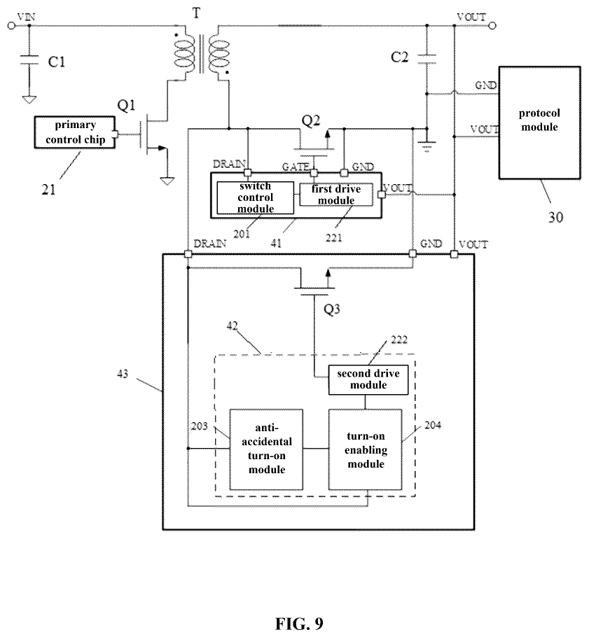

Referring to FIG. 9, FIG. 9 is a structural diagram of a synchronous rectification control apparatus according to another embodiment.

The synchronous rectification control apparatus in this embodiment includes: a primary MOS transistor Q1, a transformer T, a secondary MOS transistor Q2, an auxiliary MOS transistor Q3, a synchronous rectification control chip 41, and a turn-on control chip 42. The auxiliary MOS transistor Q3, the synchronous rectification control chip 41, and the turn-on control chip 42 serve as the secondary control circuit 22 in FIG. 3.

The auxiliary MOS transistor Q3 is connected in parallel with the secondary MOS transistor Q2.

The synchronous rectification control chip 41 is configured to control the secondary MOS transistor Q2 to turn on at a first moment for a first duration during a secondary side demagnetization process of the transformer T.

The turn-on control chip 42 is configured to control the auxiliary MOS transistor Q3 to turn on at a second moment for a second duration after the secondary MOS transistor Q2 is turned off during a resonance stage after the secondary side demagnetization process of the transformer T ends.

In this embodiment, the synchronous rectification control chip 41 includes a switch control module 201 and a first drive module 221 with similar functions as the embodiment shown in FIG. 6. That is, the switch control module 201 is configured to output a first control signal during the secondary side demagnetization process of the transformer T to control the secondary MOS transistor Q2 to turn on at the first moment for the first duration, and the first drive module 221 is configured to drive the secondary MOS transistor Q2 to turn on or off based on the first control signal.

The turn-on control chip 42 includes an anti-accidental turn-on module 203, a turn-on enabling module 204, and a second drive module 222.

The turn-on enabling module 204 is configured to output a second control signal in the resonance stage after the secondary side demagnetization process of the transformer T ends, so as to control the auxiliary MOS transistor Q3 to turn on at the second moment for the second duration after the secondary MOS transistor Q2 is turned off.

The anti-accidental turn-on module 203 is configured to detect whether the waveform of the drain-source voltage difference of the secondary MOS transistor is distorted, and output a distortion detection result signal to the turn-on enabling module 204 to control timing when the turn-on enabling module 204 outputs the second control signal, thereby ensuring that the auxiliary MOS transistor Q3 is turned on at an appropriate position.

The second drive module 222 is configured to drive the auxiliary MOS transistor Q3 to turn on or off based on the second control signal.

Compared with the embodiment shown in FIG. 6, in the synchronous rectification control apparatus shown in FIG. 9, the second turn-on mechanism is implemented by two MOS transistors in parallel on the secondary side and corresponding drive circuits. This structure can be realized by directly adding a second turn-on function to the conventional flyback system without making changes to the existing chip. In addition, the application scope of the solution can be expanded beyond an MOS synchronous rectification flyback system to other fields including but not limited to a flyback system using a power diode for passive rectification.

Referring to FIG. 9, the synchronous rectification control chip 41 can be fully compatible with conventional synchronous rectification control chips.

In some embodiments, the auxiliary MOS transistor Q3, the anti-accidental turn-on module 203, the turn-on enabling module 204, and the second drive module 222 may be encapsulated in a same chip 43 to further improve the integration of chip.

In some embodiments, the secondary MOS transistor Q2 may also be encapsulated in the synchronous rectification control chip 41.

In some embodiments, the auxiliary MOS transistor Q3 may also be encapsulated in the turn-on control chip 42.

In some embodiments, the secondary MOS transistor Q2 and the auxiliary MOS transistor Q3 may be encapsulated in the same chip.

As shown in FIG. 9, in some embodiments, the synchronous rectification control apparatus may further include a protocol module 30. In specific implementation, the protocol module 30 may be a separate chip, or may be encapsulated in the synchronous rectification control chip 41, or may be encapsulated in the turn-on control chip 42, which is not limited in the embodiments of the present disclosure.

In normal situations, in a synchronous rectification circuit, within a switching cycle, the drain-source voltage difference Vds_sec of the secondary MOS transistor goes through n (a value of n is related to an actual circuit and can be designed according to actual needs) low pulse waves and then reaches a high pulse wave. Ideally, if the waveform of Vds_sec remains stable in each cycle, the timing of the second turn-on, i.e., the second moment mentioned above, can also be maintained at the same time point in each switching cycle. However, as in practice the circuit may be affected by actual operation environment, one or more low pulses in the waveform of Vds_sec may be distorted.

In the above embodiments, the anti-accidental turn-on module 203 detects whether the waveform of the drain-source voltage difference Vds_sec of the secondary MOS transistor is distorted via, for example, width, area or slope of the waveform, and outputs a distortion detection result signal to the turn-on enabling module 204. Accordingly, the turn-on enabling module 204 can ensure that the second control signal is output at appropriate timing within a switching cycle based on the distortion detection result signal.

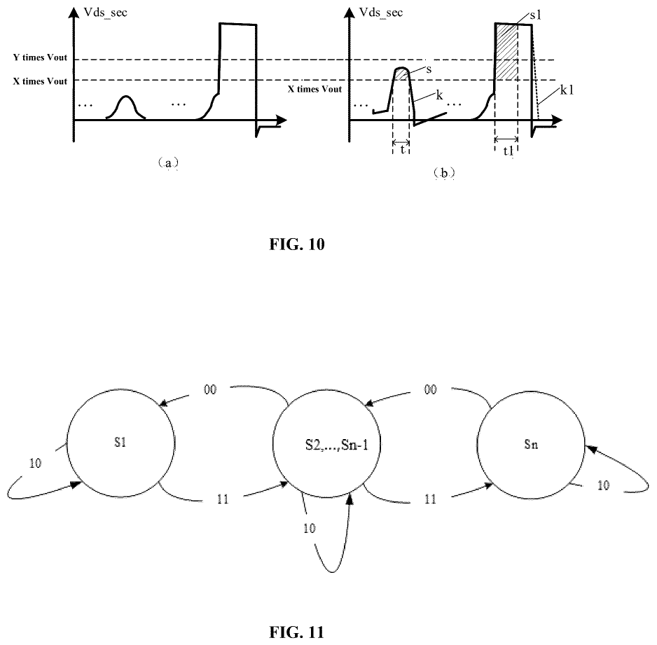

Detection principle of the anti-accidental turn-on module 203 detecting whether the waveform of the drain-source voltage difference Vds_sec of the secondary MOS transistor is distorted is described in detail in conjunction with FIG. 10.

Referring to FIG. 10, FIG. 10(a) is a schematic diagram of the waveform of Vds_sec in normal situations, and FIG. 10(b) is a schematic diagram of the waveform of Vds_sec under distortion. For ease of description, FIG. 10 only illustrates one low pulse wave and one high pulse wave in one switching cycle.

Based on signal characteristics when the waveform of Vds_sec is distorted as shown in FIG. 10, in specific implementation, the anti-accidental turn-on module 203 may detect whether the waveform of Vds_sec is distorted in a variety of ways, which are described below with examples.

In Example 1, the anti-accidental turn-on module 203 may determine whether Vds_sec is distorted by detecting a duration t during which the waveform of the voltage difference Vds_sec exceeds a certain multiple of the output voltage VOUT.

Specifically, referring to FIG. 10(b), it is determined whether the duration t during which Vds_sec exceeds X times VOUT is longer than a first set duration t1. If the duration t does not exceed t1, it is considered that there is distortion. If the duration t exceeds t1, it is considered to be a normal high pulse wave.

X may vary according to actual application environment. For example, a typical range for X may be: 2.0≤X≤4.

In Example 2, the anti-accidental turn-on module 203 may determine whether Vds_sec is distorted by detecting a volt-second products of the waveform of the voltage difference Vds_sec.

Specifically, it is determined whether the volt-second product s obtained by integrating Vds_sec in a duration when it exceeds X times VOUT is greater than a first reference value s1. If the volt-second product s does not exceed s1, it is considered that there is distortion. If the volt-second product s exceeds s1, it is considered to be a normal high pulse wave.

X may vary according to actual system environment. For example, a typical range for X may be: 2.0≤X≤4.

In example 3, the anti-accidental turn-on module 203 may determine whether Vds_sec is distorted by detecting a falling edge slope k of the waveform of the voltage difference Vds_sec.

Specifically, it is determined whether the falling edge slope k after Vds_sec exceeds X times VOUT is greater than a first reference slope k1. If the falling edge slope k does not exceed k1, it is considered that there is distortion. If the falling edge slope k exceeds k1, it is considered to be a normal high pulse wave.

For implementing the above-mentioned methods, some conventional circuits may be adopted, which is not limited in the embodiments of the present disclosure.

It should be noted that in practice, the detection of the waveform of the drain-source voltage difference Vds_sec of the secondary MOS transistor by the anti-accidental turn-on module 203 is not limited to the above three methods, and other implementation methods may be adopted. As long as a distorted waveform can be effectively distinguished while normally realizing the anti-accidental turn-on function, any method can be selected according to actual system environment.

It should be noted that a gate drive voltage when the secondary MOS transistor is turned on for the second time may be different from a gate drive voltage when it is turned on under the conventional SR mode, so that the effect of turning on the secondary MOS transistor for the second time is optimized.

Based on the detection result of the anti-accidental turn-on module 203, the turn-on enabling module 204 may turn on the secondary MOS transistor for the second time at an appropriate position.

In some embodiments, the anti-accidental turn-on module 203 analyzes and processes an analog signal of the drain DRAIN to distinguish characteristic information such as low pulse waves, distorted low pulse waves and high pulse waves. The turn-on enabling module 204 may implement the above functions by using different state machines, such as a fully increasing finite state machine, a fully decreasing finite state machine, or an adaptive increasing and decreasing finite state machine.

Taking the adaptive increasing and decreasing finite state machine as an example, the state machine includes a total of n (n low pulse waves of the waveform of the drain-source voltage difference Vds_sec of the secondary MOS transistor) legal states starting from state S1 and increasing sequentially to state Sn. The state machine can realize transition between different states based on a step counter. It should be noted that when starting control of the second turn-on, the state machine can be in any of the states.

Table 1 below illustrates state transition vectors and corresponding step counter actions in four cases defined by the detection results of the waveform of the drain-source voltage difference Vds_sec obtained by the anti-accidental turn-on module 203 and determination results of the turn-on enabling module 204 determining whether to send a second turn-on signal (i.e., the second control signal mentioned above) in a current cycle based on the detection results of the anti-accidental turn-on module 203.

TABLE 1

| whether the turn-on | Any distortion in | The | |
|---|---|---|---|
| enabling module sends | the waveform of | corresponding | |
| a second turn-on signal | Vds_sec in | state transition | The action corresponding |
| in current cycle | current cycle? | vector | to the transition vector |
| no | no | 00 | step count value minus 1 |
| no | yes | 01 | exit second turn-on mode |
| yes | no | 10 | step count value unchanged |
| yes | yes | 11 | step count value plus 1 |

FIG. 11 is a schematic diagram of state changes of the state machine.

For all states, if the transition vector is detected to be 01, it maintains a current state directly and exists the second turn-on mode until the transition vector is detected to be 00, 10 or 11.

For all states, if the transition vector is detected to be 10, the step count value remains unchanged.

For states S2 to Sn−1, if the transition vector is detected to be 11, it transitions to a next state in increment, and if the transition vector is detected to be 00, it transitions to a previous state in decrement.

For state S1, if the transition vector is detected to be 11, it transitions to state S2, and if the transition vector is detected to be 00, it maintains the current state and exits the second turn-on mode until the transition vector is detected to be 10 or 11.

For state Sn, if the transition vector is detected to be 11, it maintains the current state and exits the second turn-on mode until the transition vector is detected to be 00 or 10, and if the transition vector is detected to be 00, it transitions to state Sn−1.

It should be noted that, in the entire switching cycle, the secondary MOS transistor Q2 is controlled by the switch control module 201. Only when the secondary MOS transistor Q2 is not controlled by the switch control module 201 on turned-on, the anti-accidental turn-on module 203 will output a distortion detection signal, and convert the second control signal output by the turn-on enabling module 204 into an actual gate drive voltage Vgs, to drive the secondary MOS transistor Q2 to turn on for the second time, or drive the auxiliary MOS transistor Q3 to turn on.

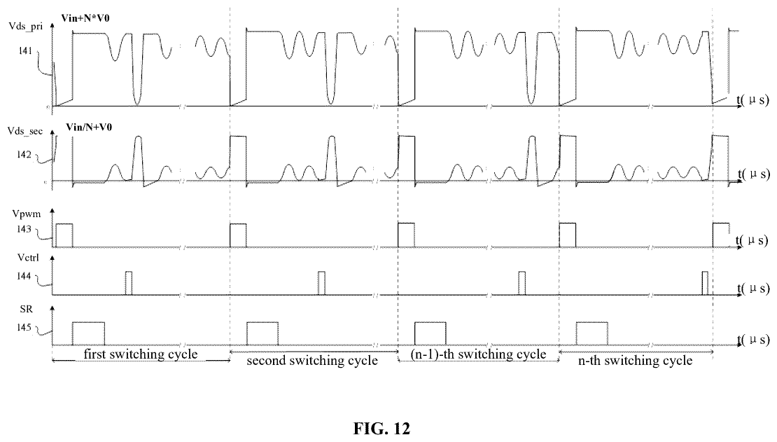

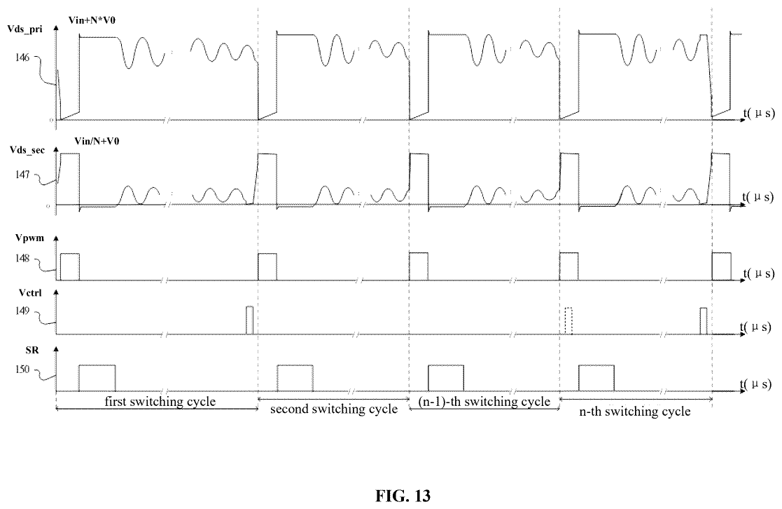

With the above state machine, a second turn-on of the secondary MOS transistor at incorrect timing may be avoided, which ensures that the secondary MOS transistor is turned on for the second time at appropriate timing in each switching cycle until it is locked. Detailed description is provided below in conjunction with FIG. 12 and FIG. 13.

Referring to FIG. 12, FIG. 12 is an operation waveform diagram of forward locking of adaptive step second turn-on of a secondary MOS transistor by using a state machine according to an embodiment.

Curves in FIG. 12 are schematic diagrams of internal waveforms of a flyback switching power supply with the secondary MOS transistor second turn-on function when performing forward adaptive step tracking.

Waveform 141 is a waveform of a source-drain voltage difference Vds_pri of the primary MOS transistor.

Waveform 142 is a waveform of a source-drain voltage difference Vds_sec of the secondary MOS transistor.

Waveform 143 is a waveform of a gate drive voltage PWM of the primary MOS transistor.

Waveform 144 is a waveform of a turn-on enabling signal Vctrl (i.e., the second control signal mentioned above, also called as enabling signal for the second turn-on) of the secondary MOS transistor.

Waveform 145 is a waveform of a drive voltage SR of the switch control module.

Referring to FIG. 12, as a position of distortion in the waveform of the source-drain voltage difference Vds_sec of the secondary MOS transistor changes, the position of the turn-on enabling signal Vctrl of the secondary MOS transistor also changes. After n switching cycles, the turn-on enabling module can correctly capture a valley of the Vds_sec waveform. After the waveform is no longer distorted and remains stable, the position of the turn-on enabling signal Vctrl of the secondary MOS transistor is relatively fixed and no longer changes.

FIG. 13 is an operation waveform diagram of backward locking of adaptive step second turn-on of a secondary MOS transistor by using a state machine according to an embodiment.

Curves in FIG. 13 are schematic diagrams of internal waveforms of a flyback switching power supply with the secondary MOS transistor second turn-on function when performing backward adaptive step tracking.

Waveform 146 is a waveform of a source-drain voltage difference Vds_pri of the primary MOS transistor.

Waveform 147 is a waveform of a source-drain voltage difference Vds_sec of the secondary MOS transistor.

Waveform 148 is a waveform of a gate drive voltage PWM of the primary MOS transistor.

Waveform 149 is a waveform of a turn-on enabling signal Vctrl (i.e., the second control signal mentioned above, also called as enabling signal for the second turn-on) of the secondary MOS transistor.

Waveform 150 is a waveform of a drive voltage SR of the switch control module.

Referring to FIG. 13, in the first switching cycle, the turn-on enabling module can correctly capture the valley of the Vds_sec waveform; in the second to (n−2)-th switching cycles, the primary side is turned on before the system generates a turn-on enabling signal Vctrl due to load changes, and the step count value inside the state machine decreases continuously with the cycle in this stage; and in the (n−1)-th switching cycle, the turn-on enabling module is about to generate the turn-on enabling signal Vctrl, but it overlaps with the next cycle, and actually only one turn-on is generated. After n switching cycles, the turn-on enabling module can correctly capture the valley of the waveform of the source-drain voltage difference Vds_sec of the secondary MOS transistor, to guarantee that the secondary MOS transistor is stably turned on twice in each switching cycle without waveform distortion.

With the synchronous rectification control apparatus provided in the embodiments of the present disclosure, appropriate timing is selected to perform an additional turn-on of the secondary MOS transistor before the primary MOS transistor is turned on. In this manner, residual energy in a primary quasi-resonant system is transitioned back to the power supply, thereby effectively reducing the source-drain voltage of the primary MOS transistor at a turn-on moment, and accordingly reducing the turn-on losses, and the temperature rise of the primary MOS transistor.

Accordingly, an embodiment of the present disclosure further provides a flyback switching power supply including the above synchronous rectification control apparatus, which has advantages of low switching losses and high efficiency compared with the conventional flyback switching power supply.

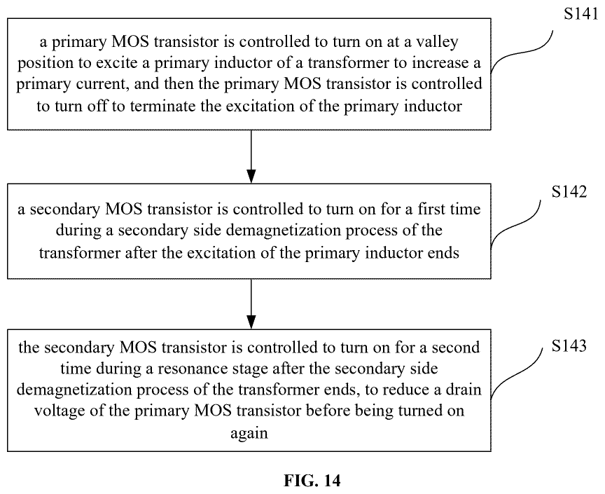

Accordingly, an embodiment of the present disclosure further provides a synchronous rectification control method. FIG. 14 is a flow chart of the method which includes following steps.

In S141, a primary MOS transistor is controlled to turn on at a valley position to excite a primary inductor of a transformer to increase a primary current, and then the primary MOS transistor is controlled to turn off to terminate the excitation of the primary inductor.

In S142, a secondary MOS transistor is controlled to turn on for a first time during a secondary side demagnetization process of the transformer after the excitation of the primary inductor ends.

In S143, the secondary MOS transistor is controlled to turn on for a second time during a resonance stage after the secondary side demagnetization process of the transformer ends, to reduce a drain voltage of the primary MOS transistor before being turned on again.

With the synchronous rectification control method provided in the embodiments of the present disclosure, the second turn-on mechanism is introduced for the secondary MOS transistor, which effectively reduces turn-on losses of the primary MOS transistor, and improves system efficiency.

In the present disclosure, unless otherwise clearly specified and limited, ordinal numbers, such as “first”, “second”, etc., are only used to distinguish and describe associated objects, and cannot be understood as indicating or implying relative importance or order between the associated objects. In addition, ordinal numbers do not represent the number of the associated objects.

“Plurality” includes two or more, and other quantifiers are similar.

The terms “or” and “and/or” in the present disclosure are used to describe the relationship between associated objects, which represent non-exclusive inclusion. For example, “A and/or B” may include: “A”, “B”, or “A and B”.

In the embodiments provided in the present disclosure, it should be understood that the disclosed methods and apparatuses can be implemented in other ways. For example, the apparatus embodiments described above are only illustrative. For example, the division of the modules is only a logical function division, and there may be other division methods in actual implementation, which is not limited in the present disclosure.

In addition, each functional module in each embodiment of the present disclosure may be integrated into one processing unit, or may be each separate physical unit, or two or more units may be integrated into one unit. The above-mentioned integrated unit may be implemented in a form of hardware, or in a form of hardware and software functional units.

The integrated unit implemented in the form of hardware and software functional units can be implemented in a form of a processor calling software. For example, a system includes a processor that is connected to a memory storing instructions, and the processor calls the instructions stored in the memory to implement any of the above methods or realize functions of each module of the system. The processor is, for example, a general-purpose processor, such as a CPU or a microprocessor, and the memory is a memory within or outside the system. The above software may be stored in a computer readable storage medium.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A synchronous rectification control apparatus, comprising: a primary Metal-Oxide-Semiconductor (MOS) transistor, a transformer, a secondary MOS transistor, a primary control chip, and a secondary control circuit;
wherein the primary control chip is configured to control the primary MOS transistor to turn on at a valley position to excite a primary inductor of the transformer to increase a primary current, and then control the primary MOS transistor to turn off to terminate the excitation of the primary inductor; and
the secondary control circuit is configured to control the secondary MOS transistor to turn on for a first time during a secondary side demagnetization process of the transformer after the excitation of the primary inductor ends, and to control the secondary MOS transistor to turn on for a second time during a resonance stage after the secondary side demagnetization process of the transformer ends, to reduce a drain voltage of the primary MOS transistor before being turned on again.

2. The synchronous rectification control apparatus according to claim 1, wherein the secondary control circuit comprises:
a switch control module, configured to output a first control signal during the secondary side demagnetization process of the transformer to control the secondary MOS transistor to turn on at a first moment for a first duration;
a turn-on enabling module, configured to output a second control signal in the resonance stage after the secondary side demagnetization process of the transformer ends, to control the secondary MOS transistor to turn on at a second moment for a second duration, wherein the second moment is later than the first moment;
an anti-accidental turn-on module, configured to detect whether a waveform of a drain-source voltage difference of the secondary MOS transistor is distorted, and output a distortion detection result signal to the turn-on enabling module to control timing when the turn-on enabling module outputs the second control signal; and
a drive module, configured to drive the secondary MOS transistor to turn on or off based on the first control signal and the second control signal.

3. The synchronous rectification control apparatus according to claim 2, wherein the switch control module, the drive module, the turn-on enabling module, and the anti-accidental turn-on module are encapsulated in a same chip.

4. The synchronous rectification control apparatus according to claim 2, wherein the switch control module and the drive module are encapsulated together as a secondary control chip, and the anti-accidental turn-on module and the turn-on enabling module are encapsulated together as a turn-on control chip.

5. The synchronous rectification control apparatus according to claim 2, wherein the secondary MOS transistor and the secondary control circuit are encapsulated in a same chip.

6. The synchronous rectification control apparatus according to claim 3, further comprising:
a protocol module, configured to regulate an output terminal voltage VOUT to make the output terminal voltage VOUT meet a set standard.

7. The synchronous rectification control apparatus according to claim 4, further comprising:
a protocol module, configured to regulate an output terminal voltage VOUT to make the output terminal voltage VOUT meet a set standard.

8. The synchronous rectification control apparatus according to claim 5, further comprising:
a protocol module, configured to regulate an output terminal voltage VOUT to make the output terminal voltage VOUT meet a set standard.

9. The synchronous rectification control apparatus according to claim 4, further comprising:
a protocol module, configured to regulate an output terminal voltage VOUT to make the output terminal voltage VOUT meet a set standard;
wherein the protocol module is encapsulated in the turn-on control chip.

10. The synchronous rectification control apparatus according to claim 5, further comprising:
a protocol module, configured to regulate an output terminal voltage VOUT to make the output terminal voltage VOUT meet a set standard;
wherein the protocol module and the secondary control circuit are encapsulated in a same chip.

11. The synchronous rectification control apparatus according to claim 1, wherein the secondary control circuit comprises:
an auxiliary MOS transistor, connected in parallel with the secondary MOS transistor;
a synchronous rectification control chip, configured to control the secondary MOS transistor to turn on at a first moment for a first duration during the secondary side demagnetization process of the transformer; and
a turn-on control chip, configured to control the auxiliary MOS transistor to turn on at a second moment for a second duration after the secondary MOS transistor is turned off during the resonance stage after the secondary side demagnetization process of the transformer ends.

12. The synchronous rectification control apparatus according to claim 11, wherein the secondary MOS transistor is encapsulated in the synchronous rectification control chip.

13. The synchronous rectification control apparatus according to claim 11, wherein the auxiliary MOS transistor is encapsulated in the turn-on control chip.

14. The synchronous rectification control apparatus according to claim 11, wherein the auxiliary MOS transistor and the secondary MOS transistor are encapsulated in a same chip.

15. The synchronous rectification control apparatus according to claim 11, wherein the synchronous rectification control chip comprises:
a switch control module, configured to output a first control signal during the secondary side demagnetization process of the transformer to control the secondary MOS transistor to turn on at the first moment for the first duration; and
a drive module, configured to drive the secondary MOS transistor to turn on or off based on the first control signal.

16. The synchronous rectification control apparatus according to claim 15, wherein the turn-on control chip comprises:
a turn-on enabling module, configured to output a second control signal in the resonance stage after the secondary side demagnetization process of the transformer ends, to control the auxiliary MOS transistor to turn on at the second moment for the second duration after the secondary MOS transistor is turned off;
an anti-accidental turn-on module, configured to detect whether a waveform of a drain-source voltage difference of the secondary MOS transistor is distorted, and output a distortion detection result signal to the turn-on enabling module to control timing when the turn-on enabling module outputs the second control signal; and
a second drive module, configured to drive the auxiliary MOS transistor to turn on or off based on the second control signal.

17. The synchronous rectification control apparatus according to claim 15, further comprising:
a protocol module, configured to regulate an output terminal voltage VOUT to make the output terminal voltage VOUT meet a set standard;
wherein the protocol module is independent of the synchronous rectification control chip and the turn-on control chip, or the protocol module is encapsulated in the synchronous rectification control chip, or the protocol module is encapsulated in the turn-on control chip.

18. The synchronous rectification control apparatus according to claim 16, wherein the anti-accidental turn-on module is configured to control the turn-on enabling module to output the second control signal through a state machine.

19. A flyback switching power supply, comprising the synchronous rectification control apparatus which comprises a primary Metal-Oxide-Semiconductor (MOS) transistor, a transformer, a secondary MOS transistor, a primary control chip, and a secondary control circuit;
wherein the primary control chip is configured to control the primary MOS transistor to turn on at a valley position to excite a primary inductor of the transformer to increase a primary current, and then control the primary MOS transistor to turn off to terminate the excitation of the primary inductor; and
the secondary control circuit is configured to control the secondary MOS transistor to turn on for a first time during a secondary side demagnetization process of the transformer after the excitation of the primary inductor ends, and to control the secondary MOS transistor to turn on for a second time during a resonance stage after the secondary side demagnetization process of the transformer ends, to reduce a drain voltage of the primary MOS transistor before being turned on again.

20. A synchronous rectification control method, comprising:
controlling a primary Metal-Oxide-Semiconductor (MOS) transistor to turn on at a valley position to excite a primary inductor of a transformer to increase a primary current, and then controlling the primary MOS transistor to turn off to terminate the excitation of the primary inductor;
controlling a secondary MOS transistor to turn on for a first time during a secondary side demagnetization process of the transformer after the excitation of the primary inductor ends; and
controlling the secondary MOS transistor to turn on for a second time during a resonance stage after the secondary side demagnetization process of the transformer ends, to reduce a drain voltage of the primary MOS transistor before being turned on again.
